(19) United States
(12) Patent Application Publication
(10) Pub. No.: US 2014/0023252 A1
(43) Pub. Date: Jan. 23, 2014

(54) IMAGE PROCESSING APPARATUS, IMAGE PROCESSING METHOD AND IMAGE PROCESSING PROGRAM

(71) Applicant: FUJIFILM Corporation, Tokyo (JP)

(72) Inventor: Yoshiro IMAI, Ashigarakami-gun (JP)

(73) Assignee: FUJIFILM Corporation, Tokyo (JP)

(21) Appl. No.: 14/033,647

(22) Filed: Sep. 23, 2013

Related U.S. Application Data
(63) Continuation of application No. PCT/JP2012/002010, filed on Mar. 23, 2012.

(30) Foreign Application Priority Data
Mar. 24, 2011 (JP) 2011-065511

(51) Int. Cl. G06T 5/50

(52) U.S. Cl. CPC G06T 5/50
USPC 382/130

(57) ABSTRACT

A first processed signal is extracted by extracting an input spatial frequency component corresponding to a periodic pattern by performing filtering processing on an image signal. A subject component of an image included in the extracted first processed signal is extracted from the first processed signal. A second processed signal is extracted by subtracting the first processed signal from the image signal and also by adding the extracted subject component to the image signal.

### BACKGROUND OF THE INVENTION

1. Field of the Invention

The present invention relates to a periodic pattern suppression method and apparatus that suppresses a spatial frequency component corresponding to a periodic pattern in an image signal.

2. Description of the Related Art

Conventionally, storable phosphors (photostimulable phosphors) have been used. When a storable phosphor is irradiated with radiation (X-rays, α-rays, β-rays, γ-rays, an electron beam, ultraviolet rays or the like), apart of radiation energy is stored in the storable phosphor. After then, when excitation light, such as visible light and a laser beam, is output to the storable phosphor, the storable phosphor emits photoluminescence corresponding to the radiation energy stored therein. For example, a radiographic image readout apparatus using the storable phosphor is widely used in CR (Computed Radiography). A storable phosphor sheet, in which the storable phosphor is deposited on a substrate, is irradiated with radiation that has passed through a subject, such as a human body, and radiographic information is temporarily stored and recorded on the storable phosphor sheet. Excitation light, such as a laser beam, is output to the storable phosphor sheet to induce photoluminescence. Further, photoelectric conversion is performed on the photoluminescence to obtain an image signal.

Here, when a radiographic image of a subject is imaged and recorded on the storable phosphor sheet or the like, imaging is performed by placing a grid between the subject and the sheet in some cases so that radiation scattered by the subject does not irradiate the sheet. For example, lead or the like, which does not pass radiation therethrough, and aluminum, wood or the like, which tends to pass radiation therethrough, are alternately arranged at a narrow pitch of 4 line/mm in the grid. When radiography is performed by using the grid, radiation scattered by the subject does not tend to irradiate the sheet. Therefore, it is possible to improve the contrast of the radiographic image of the subject. However, when the size of this image including the grid image is enlarged or reduced, aliasing due to folding occurs depending on the magnification or reduction ratio. Further, when aliasing overlaps with the spatial frequency of the grid image or the like, a narrow stripe pattern (moire) is generated, and observation of a regenerated image becomes difficult.

U.S. Patent Application Publication No. 20030091243 (Patent Document 1) discloses a method for removing a grid image, as a method for removing such a periodic pattern from an image. In the method for removing the grid image, one-dimensional high-pass filter processing is performed on the image in a direction in which the stripe pattern of the grid image is arranged. Further, one-dimensional low-pass filter processing is performed on the image in a direction parallel to the stripe pattern of the grid image. Accordingly, a spatial frequency component corresponding to the grid image is extracted from an original image, and the extracted spatial frequency component is subtracted from the original image.

Japanese Patent No. 3445258 (Patent Document 2) proposes a method for obtaining an image in which an artifact caused by a grid has been effectively removed in radiographic image processing, in which radiographic image data of a subject obtained by performing radiography using the grid for removing radiation scattered by the subject are processed. First, data (band component) representing a first image component, in other words, a grid component are extracted from radiographic image data of the subject including the grid component. Then, second image component data, which are caused by the grid included in the radiographic image data, are generated based on the first image component data. The generated second image component data, in other words, data of a component caused by the grid are removed from original radiographic image data, in other words, the whole image including the grid component.

Japanese Unexamined Patent Publication No. 2010-240259 (Patent Document 3) discloses a method for removing a grid. A band-pass grid image, which has been extracted from an original image by a band-pass filter, and a high-pass grid image, which has been extracted from the original image by a high-pass filter, are obtained to subtract a remaining grid image, which has not been removed as a grid image, from an original image. A difference grid image (a grid frequency component that has not been fully extracted by band-pass) is obtained by performing low-pass processing on a difference image, which is a difference between the two grid images, in a direction parallel to a grid pattern. An image obtained by adding the difference grid image and the band-pass grid image together is subtracted from the original image.

### SUMMARY OF THE INVENTION

Here, there is a demand for removing a periodic pattern, such as moire, without removing a component representing a subject as possible to obtain a high quality image appropriate for diagnosis based on the image. However, in the methods disclosed in Patent Documents 1 through 3, when a detected spatial frequency component in a predetermined band corresponding to a periodic pattern is removed from an image, there has been a problem that a subject component representing a subject, and which is included in the predetermined band, is removed together. Especially, when a moire component caused by a grid is present in a low spatial frequency band including many subject components representing the subject, the quality of an image deteriorates significantly in the methods disclosed in Patent Documents 1 through 3.

In view of the foregoing circumstances, it is an object of the present invention to provide an image processing apparatus, an image processing method and an image processing program that can extract a subject component from a frequency component corresponding to a periodic pattern, and restore the extracted subject component to an original image.

An image processing apparatus of the present invention is an image processing apparatus that suppresses a spatial frequency component corresponding to a periodic pattern included in an image, the apparatus comprising:

a first processed signal extraction means that extracts a first processed signal by extracting an input spatial frequency component corresponding to the periodic pattern by performing filtering processing on the image signal;

a subject component extraction means that extracts, from the extracted first processed signal, a subject component of the image, and the subject component being included in the first processed signal; and

a second processed signal extraction means that extracts a second processed signal by subtracting the first processed signal from the image signal and also by adding the extracted subject component to the image signal.

An image processing method of the present invention is an image processing method that suppresses a spatial frequency component corresponding to a periodic pattern included in an image, the method comprising the steps of:

extracting a first processed signal by extracting an input spatial frequency component corresponding to the periodic pattern by performing filtering processing on the image signal;

extracting, from the extracted first processed signal, a subject component of the image, and the subject component being included in the first processed signal; and

extracting a second processed signal by subtracting the first processed signal from the image signal and also by adding the extracted subject component to the image signal.

An image processing program of the present invention is an image processing program that suppresses a spatial frequency component corresponding to a periodic pattern included in an image, the program causing a computer to function as:

a first processed signal extraction means that extracts a first processed signal by extracting an input spatial frequency component corresponding to the periodic pattern by performing filtering processing on the image signal;

a subject component extraction means that extracts, from the extracted first processed signal, a subject component of the image, and the subject component being included in the first processed signal; and

a second processed signal extraction means that extracts a second processed signal by subtracting the first processed signal from the image signal and also by adding the extracted subject component to the image signal.

The term “periodic pattern” means a noise having a periodic pattern included in an original image. For example, the periodic pattern means a grid image, moire or the like included in an original image when a radiographic image is imaged on a storable phosphor sheet by using the grid.

Further, the “input” spatial frequency component corresponding to the periodic pattern includes a spatial frequency component corresponding to the periodic pattern, and which has been input by any method. For example, a known spatial frequency component corresponding to a periodic pattern may be input by a user' s manual input. Alternatively, the image processing apparatus may further include a periodic pattern detection means that detects, in the image signal, a spatial frequency component corresponding to the periodic pattern, and that inputs the detected spatial frequency component to the first processed signal extraction means. Further, the spatial frequency component corresponding to the periodic pattern, and which has been detected by the periodic pattern detection means, may be input.

In the image processing apparatus of the present invention, it is desirable that the subject component extraction means extracts, from the first processed signal, a high contrast component exceeding a predetermined threshold, as the subject component.

Here, the term “contrast” means a difference in density values between a light part and a dark part in an image, and which are represented by density values of the image. The term “high contrast” means that the absolute value of a difference in density values from a neighboring pixel is greater than a predetermined threshold.

The threshold may differ depending on an imaged region or an imaging condition of the image. Here, an imaged region of an image and an imaging condition of the image may be obtained by using an imaging menu, such as information about the imaging condition and the imaged region, which is specified at an imaging apparatus of an original image. Alternatively, imaged region information, such as an organ of a subject and a lesion, which has been input by a user through his/her manual operation may be used. Further, an image processing apparatus of the present invention may further include a region extraction means that extracts an imaged region of the image from the image, and use the extracted imaged region information. For example, methods disclosed in Japanese Unexamined Patent Publication No. 2002-109548 and Japanese Unexamined Patent Publication No. 2003-006661, which are proposed by the applicant of the present application, may be used. In the methods, a thorax is automatically detected by performing template matching using a template that is substantially similar to the outline of an average cardiothorax, as reference.

The second processed signal extraction means in the image processing apparatus of the present invention may subtract the first processed signal from the image signal and also add the subject component to the image signal in an arbitrary order as long as the second processed signal, in which the first processed signal is subtracted from the image signal and the subject component is added to the image signal, is finally extractable. For example, the second processed signal extraction means may extract the second processed signal by subtracting the first processed signal from the image signal, and by adding the extracted subject component to the image signal after subtraction. Alternatively, the second processed signal extraction means may extract the second processed signal by subtracting the extracted subject component from the first processed signal to obtain a signal, and by subtracting the obtained signal from the image signal.

According to an image processing apparatus, an image processing method and an image processing program of the present invention, a first processed signal is extracted by extracting an input spatial frequency component corresponding to a periodic pattern by performing filtering processing on an image signal. Further, a subject component of an image, and the subject component being included in the first processed signal, is extracted from the extracted first processed signal. Further, a second processed signal is extracted by subtracting the first processed signal from the image signal and also by adding the extracted subject component to the image signal. Therefore, it is possible to extract a subject component from the frequency component corresponding to the periodic pattern, and to restore the subject component to the original image. Hence, it is possible to remove only the periodic pattern, such as moire, while a component representing the subject, which is important information for diagnosis, is maintained. Consequently, it is possible to obtain, as the second processed image, a high quality image appropriate for diagnosis based on the image.

### BRIEF DESCRIPTION OF THE DRAWINGS

FIG. 1 is a schematic diagram illustrating a radiography apparatus;

FIG. 2 is a diagram illustrating a radiographic image obtained by imaging with a grid;

FIG. 3 is a perspective view illustrating an example of a radiographic image readout apparatus;

FIG. 4 is a diagram illustrating a relationship between scan directions and an image to be read out;

FIG. 5 is a schematic diagram illustrating the configuration of an image processing apparatus according to a first embodiment of the present invention;

FIG. 6 is a diagram illustrating an example of a lookup table for extracting a high contrast component from a first processed image; and

FIG. 7 is a schematic diagram illustrating the configuration of an image processing apparatus according to a modified example of the first embodiment.

### DESCRIPTION OF THE PREFERRED EMBODIMENTS

Hereinafter, embodiments of the present invention will be described with reference to drawings. In the following embodiments, a case in which a periodic pattern suppression processing apparatus according to the present invention is used in a radiographic image readout apparatus will be described. Alternatively, the periodic pattern suppression processing apparatus may be used in an image processing apparatus or the like for suppressing a periodic pattern included in a photographic image that was obtained in ordinary photography using a digital camera or the like when photography was performed through a window screen, a blind or the like. Here, the radiographic image readout apparatus reads out, as a digital image signal, a radiographic image of a human body recorded on a storable phosphor sheet by scanning the radiographic image with a laser beam.

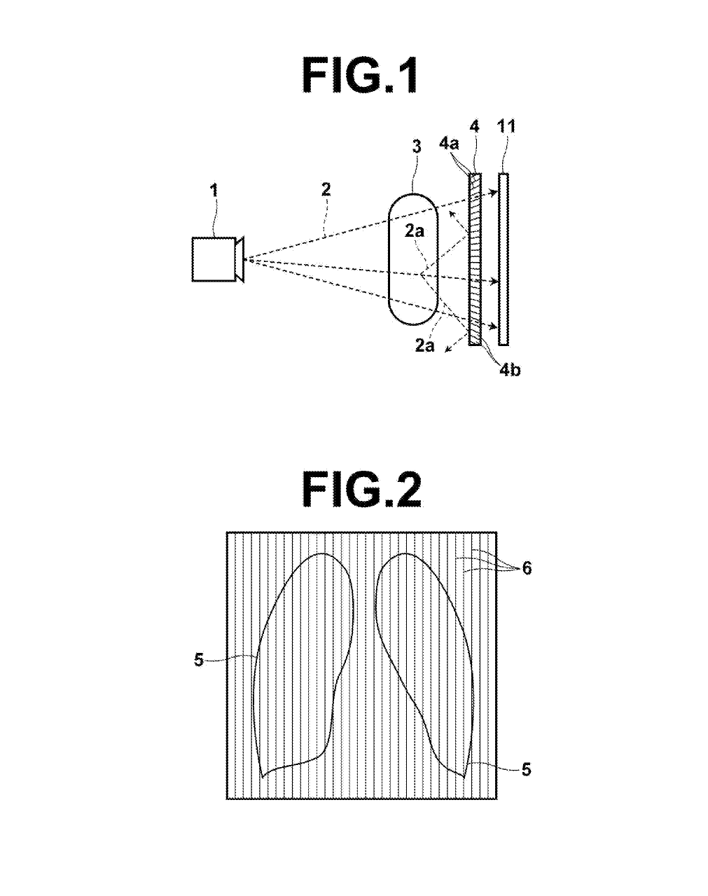

FIG. 1 is a schematic diagram illustrating a radiography apparatus. Radiation 2 is output from a radiation source 1, and passes through a subject 3, and reaches a static grid (hereinafter, simply referred to as “grid”) 4. In the grid 4, lead 4a, which absorbs the radiation 2, and aluminum 4b, which passes the radiation 2, are alternately arranged, for example, at a pitch of about 4 line/mm. Further, the lead 4a is set in such a manner that the inclination of the lead 4a is slightly different depending on its position so that the radiation 2 passes through the aluminum 4b, and enters a storable phosphor sheet 11.

Therefore, the radiation 2 that has passed through the subject 3 is absorbed by the lead 4a, and does not reach the storable phosphor sheet 11. However, the radiation 2 passes through the aluminum 4b, and reaches the storable phosphor sheet 11. A grid image of a stripe pattern of 4 line/mm is recorded on the storable phosphor sheet 11 together with a subject image. Meanwhile, scattered radiation 2a, which is scattered in the subject 3, is absorbed by the lead 4a, which is set in such a manner to be inclined depending on its position, or reflected by the surface of the grid 4. Therefore, the scattered radiation 2a does not reach the storable phosphor sheet 11. Hence, the storable phosphor sheet 11 can record a sharp radiographic image with a little amount of scattered radiation 2a irradiating the storable phosphor sheet 11. FIG. 2 is a diagram illustrating an example of a radiographic image of a subject image 5 and a grid image 6. The radiographic image is stored and recorded on the storable phosphor sheet 11 when radiography is performed by using the radiography apparatus illustrated in FIG. 1.

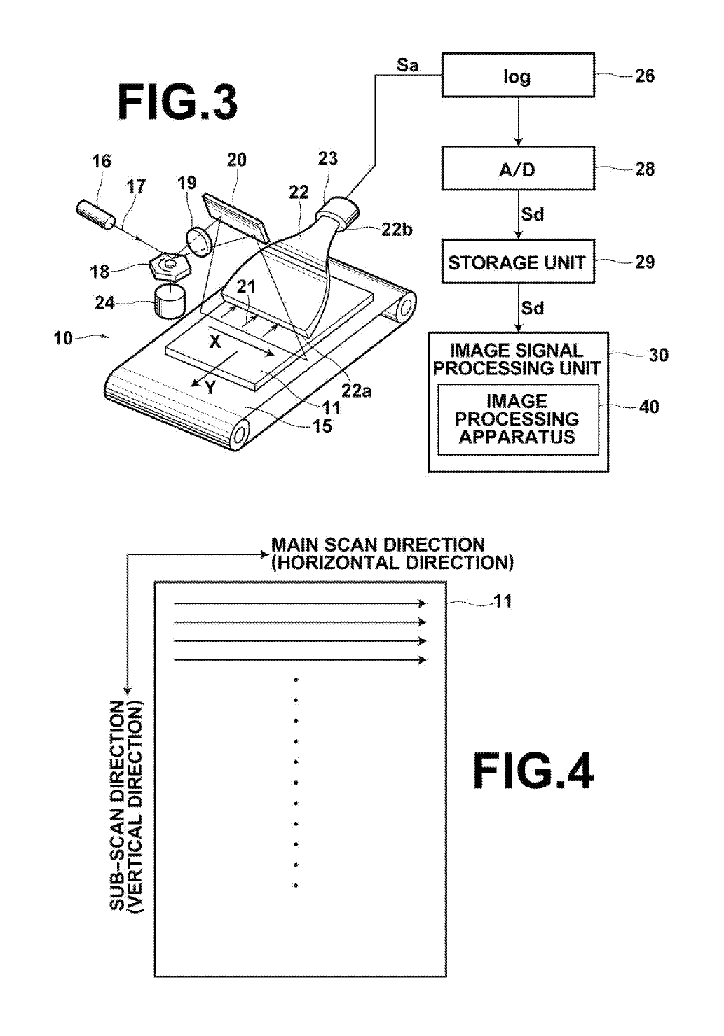

FIG. 3 is a diagram illustrating a perspective view and a functional block diagram of a radiographic image readout apparatus in combination. The storable phosphor sheet 11 is set at a predetermined position of a readout unit 10, and conveyed by a sheet conveyance means 15, such as an endless belt, which is driven by a drive means (not illustrated). The storable phosphor sheet 11 is conveyed (sub-scanned) in the direction of arrow Y, for example, at a scan pitch of 10 line/mm. Meanwhile, a light beam 17 is output from a laser beam source 16, and reflected by a rotary polyhedral mirror 18 toward a condensing lens 19, such as an fθ lens. The rotary polyhedral mirror 18 is driven by a motor 24, and rotates at high speed in the direction of an arrow. After the light beam 17 passes through the condensing lens 19, the light beam 17 is reflected by a mirror 20 toward the storable phosphor sheet 11. The storable phosphor sheet 11 is main-scanned by the light beam 17 in the direction of arrow X, which is at a substantially right angle to the sub-scan direction (the direction of arrow Y).

When the storable phosphor sheet 11 is illuminated with the light beam 17, stimulated emission light 21 in an amount corresponding to radiographic image information stored and recorded at an illuminated position of the storable phosphor sheet 11 is emitted from the position. The stimulated emission light 21 enters a light guide 22 from an incident end surface 22a of the light guide 22, and repeats total reflection in the light guide 22, and is output from an output end surface 22b of the light guide 22. The output stimulated emission light 21 is received by a photomultiplyer 23, and converted into analog image signal Sa by photoelectric conversion.

After the analog image signal Sa is logarithmically amplified by a log amplifier 26, the analog image signal Sa is sampled with a sampling interval corresponding to a spatial frequency of fs=10 cycle/mm and digitized by an A/D converter 28, and digital image signal Sd (hereinafter, simply referred to as “image signal Sd”) is output. The image signal Sd represents radiographic image information obtained by two-dimensionally scanning the storable phosphor sheet 11. As illustrated in FIG. 4, the radiographic image information is obtained by moving the storable phosphor sheet 11 in a sub-scan direction (vertical direction) while the storable phosphor sheet 11 is scanned with the light beam 17 in a main scan direction (horizontal direction). The image signal Sd obtained in this manner includes information about a grid image 6 corresponding to the grid 4 in addition to information about the radiographic image 5 corresponding to the subject 3.

After the image signal Sd is temporarily stored in a storage unit 29, the image signal Sd is input to an image signal processing unit 30. The image signal processing unit 30 includes an image processing apparatus 40 for performing an image processing method in the present invention.

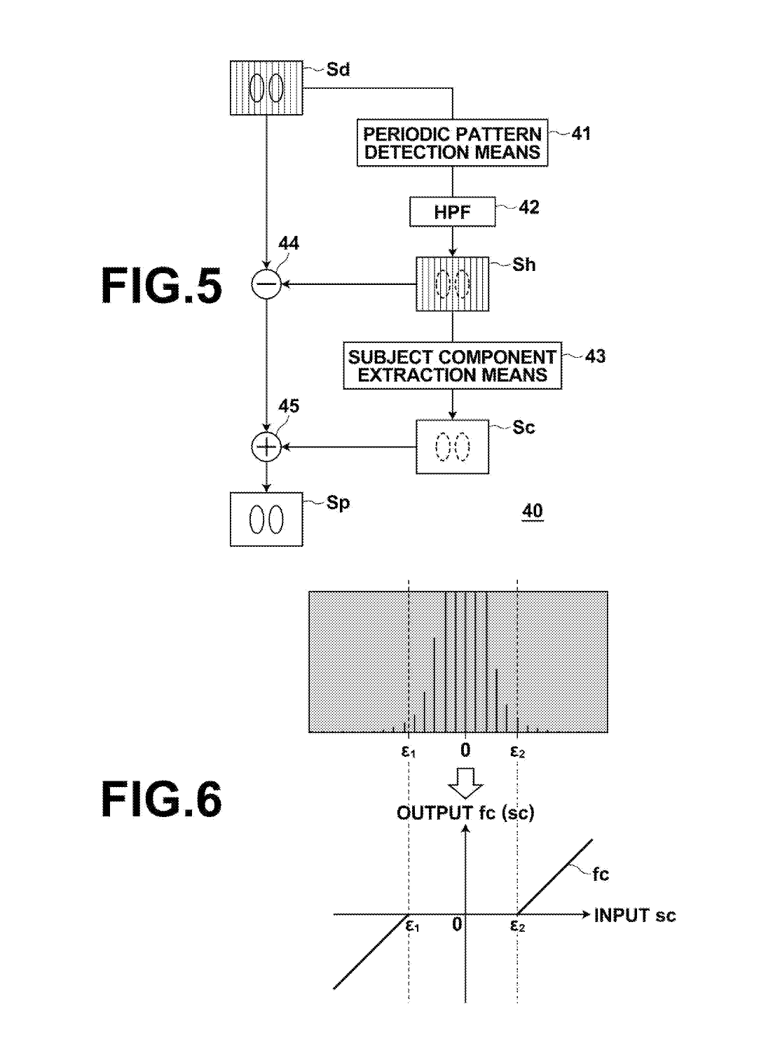

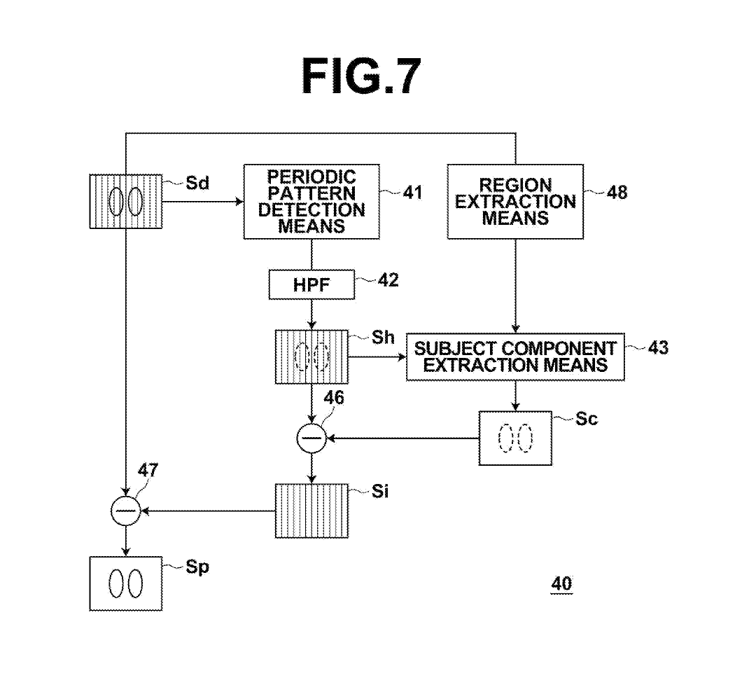

FIG. 5 is a schematic block diagram illustrating the configuration of the image processing apparatus 40 in the first embodiment. FIG. 6 is a diagram for explaining subject component extraction processing in the embodiment of the present invention. FIG. 7 is a schematic block diagram illustrating the configuration of the image processing apparatus 40 in a modified example of the embodiment of the present invention. The image processing apparatus 40 according to the embodiment of the present invention will be described with reference to FIG. 5 through FIG. 7.

The image processing apparatus 40 in the embodiment of the present invention is an image processing apparatus that suppresses a spatial frequency component corresponding to a periodic pattern included in an image. The image processing apparatus 40 includes a periodic pattern detection means 41, a first processed signal extraction means 42, a subject component extraction means 43, and second processed signal extraction means 44, 45. The periodic pattern detection means 41 detects, in an image signal, a spatial frequency component corresponding to a periodic pattern. The first processed signal extraction means 42 extracts a first processed signal by extracting the detected spatial frequency component corresponding to the periodic pattern by performing filtering processing on the image signal. The subject component extraction means 43 extracts, from the extracted first processed signal, a subject component of the image, and the subject component being included in the first processed signal. The second processed signal extraction means 44, 45 extract a second processed signal by subtracting the first processed signal from the image signal and also by adding the extracted subject component to the image signal.

An image processing program in an embodiment of the present invention and data to which the image processing program refers are stored in the storage unit 29 when the image processing program is installed, and loaded in a memory included in the storage unit 29 when the image processing program is started. The image processing program defines periodic pattern detection processing, first processed signal extraction processing, subject component extraction processing and second processed signal extraction processing, as processing performed by a central processing unit of the image signal processing unit 30, which constitutes the image processing apparatus 40. The central processing unit executes each of the aforementioned kinds of processing based on the program. Accordingly, the central processing unit of the image signal processing unit 30 functions as the periodic pattern detection means 41, the first processed signal extraction means 42, the subject component extraction means 43, and the second processed signal extraction means 44, 45.

As illustrated in FIG. 5, the periodic pattern detection means 41 reads out image signal Sd from the storage unit 29, and detects a spatial frequency corresponding to a periodic pattern by using a known method, as disclosed in Patent Document 1 and Japanese Unexamined Patent Publication No. 2003-233818, which were filed by the applicant of the present application. The first processed signal extraction means 42 includes a high-pass filter or a band-pass filter, which removes a spatial frequency band. The first processed signal extraction means 42 performs filtering processing in such a manner to pass the detected spatial frequency band corresponding to the periodic pattern. Here, the first processed signal extraction means 42 extracts first processed signal Sh by performing, on image signal Sd from the storage unit 29, one-dimensional high-pass filter (HPF) processing in both of a horizontal direction and a vertical direction. The first processed signal extraction means 42 may use any filter as long as first processed signal Sh is extracted by performing filtering processing on image signal Sd in such a manner to pass the spatial frequency band corresponding to the periodic pattern. Filtering processing may be performed by a two-dimensional filter or filters, or by a two-dimensional filter.

The subject component extraction means 43 extracts, as the subject component, a high contrast component exceeding a predetermined threshold from first processed signal Sh. As will be described later, the subject component extraction means 43 obtains first processed signal Sh, and refers to lookup table fs[sc] based on contrast sc of the first processed signal Sh. The subject component extraction means 43 extracts, as the subject component, signal Sc representing a high contrast component from the first processed signal.

With reference to FIG. 6, processing by the subject component extraction means 43 to extract, as a subject component, a high contrast component included in the first processed signal will be described.

The subject component extraction means 43 analyzes the contrast of first processed signal Sh, and performs, based on lookup table fs[sc], function processing corresponding to the contrast of the first processed signal Sh. The upper diagram of FIG. 6 is a histogram representing the contrast of first processed signal Sh, and the lower diagram of FIG. 6 is a graph of a function used by the subject component extraction means 43. In the graph illustrated in the lower diagram of FIG. 6, the horizontal axis is input sc (specifically, contrast of first processed signal Sh), and the vertical axis is output (specifically, fs[sc]). In the graph of fs[sc], output=0 when ε₁≦sc≦ε₂, and the output increases or decreases in proportion to signal Sh when sc>ε₂ or sc<ε₁. In other words, only a component less than ε₁ and a component greater than ε₂ in the upper diagram of FIG. 6 are extracted as high contrast components. Further, in the embodiment of the present invention, the absolute value of output fs[sc] is larger as contrast sc of first processed signal Sh is larger, as illustrated in lookup table fs in the lower diagram of FIG. 6.

The lower diagram of FIG. 6 corresponds to the following expression:

$$\begin{matrix}[ Expression 1 ] & \\ fs [ sc ] = \{ \begin{matrix}sc - {ɛ}_{1} & ( sc < {ɛ}_{1} ) \\ 0 & ( {ɛ}_{1} \leq sc \leq {ɛ}_{2} ) \\ sc - {ɛ}_{2} & ( sc > {ɛ}_{2} ) .\end{matrix} & ( 1 )\end{matrix}$$

In the embodiment of the present invention, lookup table fs[sc] illustrated in the lower diagram of FIG. 6 outputs a difference between contrast sc and threshold ε₁ or a difference between contrast sc and ε₂. Such correspondence between an input signal and an output signal may be set in an arbitrary manner by using a known method. For example, an input signal may be used directly as an output signal. Alternatively, appropriate weighting may be performed on contrast sc to get an output signal.

The second processed signal extraction means in the embodiment of the present invention includes a subtractor 44 and an adder 45. The subtractor 44 subtracts first processed signal Sh from image signal Sd. After then, the adder 45 adds signal Sc representing a high contrast component. Accordingly, the second processed signal extraction means extracts second processed signal Sp representing an image in which a periodic pattern has been suppressed. Here, Second Processed Signal Sp=(Image Signal Sd−First Processed Signal Sh+Signal Sc, which corresponds to a subject component in the first processed signal). Further, an image corresponding to the second processed signal Sp is displayed on a display means, such as a monitor (not illustrated), or output to an output means, such as a printer (not illustrated).

According to the embodiment of the present invention, it is possible to extract a subject component from the frequency component corresponding to the periodic pattern, and to restore the extracted subject component to the original image. Hence, it is possible to remove only the periodic pattern, such as moire, while a component that represents the subject, and that is included in the frequency band of the periodic pattern such as moire, is maintained. Consequently, it is possible to obtain, as the second processed image, a high quality image appropriate for diagnosis based on the image.

Patent Documents 1 through 3 in the related art disclose removal of a grid image extracted as a high frequency component. When these methods are applied to moire that is detected as a low frequency component, many subject components included in the low frequency component are removed together with the moire component. Therefore, the subject component in the image after processing deteriorates. Hence, it has been difficult to maintain an image quality appropriate for diagnosis based on the image. However, when the image processing method according to the embodiment of the present invention is applied to moire, which is detected as a low frequency component, it is possible to appropriately remove only the moire component while many subject components included in the low frequency component are maintained, compared with the techniques in the related art, because it is possible to generate a second processed image in which a component that represents a subject, and that is included in a frequency band of a periodic pattern, such as moire, is added.

Further, the inventor of the present invention has found, after diligent research, that the contrast of moire generated as a folding distortion of a periodic pattern of a grid tends to be relatively low, compared with that of a subject obtained by actual imaging. Therefore, according to the embodiment of the present invention, it is possible to remove only a low contrast component from a frequency component that corresponds to the periodic pattern, such as a moire stripe, which is a folding distortion, in an concentrated manner by using a high contrast component as a subject component. Accordingly, it is possible to obtain a high quality image in which the subject component is appropriately maintained.

A modified example of the embodiment of the present invention will be described.

In the embodiment of the present invention, subtraction processing by the subtractor 44 and addition processing by the adder 45 may be performed in any order as long as signal Sp, which is represented by Second Processed Signal Sp=(Image Signal Sd−First Processed Signal Sh+Signal Sc, which corresponds to a subject component in the first processed signal), is obtainable. Any method may be used to restore the signal Sc, which corresponds to the subject component in the first processed signal, to obtain the second processed signal Sp. For example, as in the aforementioned embodiment, the second processed signal extraction means may extract the second processed signal by subtracting the first processed signal from the image signal, and by adding the extracted subject component to the image signal after subtraction. Alternatively, for example, the second processed signal extraction means may include a subtractor 46 and a subtractor 47, as illustrated in FIG. 7. In this case, the second processed signal Sp may be extracted in the following manner. The subtractor 46 subtracts signal Sc representing the extracted subject component from first processed signal Sh to obtain signal Si, and the subtractor 47 subtracts the signal Si from the image signal Sd to extract the second processed signal Sp.

In lookup table fs in the aforementioned embodiment, the values of threshold ε₁ and/or ε₂ may be set at arbitrary values based on an imaged region, an imaging condition, or the like. For example, ε₁ and ε₂ may be set in such a manner that the upper (lower) N % (N=3, 5, or the like) of the histogram in the upper diagram of FIG. 6 is extracted. Alternatively, standard deviation σ of the histogram may be calculated, and ε₁ and ε₂ may be set as ε₁=ε₂=±N×σ (N=1.5, 2.0, or the like) For example, a correspondence table in which a threshold is linked with each imaged region and each imaging condition may be stored in the storage unit 29 in advance. Further the subject component extraction means may identify, based on the correspondence table, a threshold condition linked with the imaged region or the imaging condition of an image to be processed. Further, the subject component extraction means may extract a high contrast component by using the identified threshold condition.

In that case, it is possible to appropriately extract a subject component based on a threshold condition corresponding to the imaged region and the imaging condition. Therefore, it is possible to appropriately extract the second processed signal. Consequently, it is possible to generate a higher quality processed image.

In lookup table fs in the aforementioned embodiment, different lookup table fs may be used depending on the imaged region, the imaging condition or the like. For example, lookup table fs maybe selectable, based on the imaged region, the imaging condition, or the like, from plural functions (for example, function fs, function fs1, function fs2, and the like). In this case, the imaged region and the imaging condition of the image may be obtained by using an imaging menu, such as the imaging condition and information about the imaged region, which is specified at an imaging apparatus of the original image. Alternatively, imaged region information, such as an organ of the patient and a lesion, which has been input by a user through a manual operation may be used. Since it is possible to appropriately extract the subject component based on the lookup table corresponding to the imaged region and the imaging condition, it is possible to appropriately extract the second processed signal. Consequently, it is possible to generate a higher quality processed image.

Further, the image processing apparatus 40 may further include a region extraction means 48 that extracts an imaged region of an image, as illustrated in FIG. 7, and use the extracted imaged region information. As a method for extracting imaged region information, any method may be adopted as long as a region, a lesion or the like can be extracted. For example, methods disclosed in Japanese Unexamined Patent Publication No. 2002-109548 and Japanese Unexamined Patent Publication No. 2003-006661, which are proposed by the applicant of the present application, may be used. In the methods, a thorax is automatically detected by performing template matching using a template that is substantially similar to the outline of an average cardiothorax, as reference.

In such a case, the subject component extraction means 43 does not need a user' s input operation of an imaged region, and can extract an imaged region based on the result of automatic extraction. Therefore, it is possible to appropriately extract a subject component based on the extracted imaged region. Hence, a user can easily generate a high quality processed image based on the imaged region. Further, when the subject component extraction means 43 automatically extracts an imaged region or an imaging condition from an imaging menu, and extracts a subject component based on the result of automatic extraction, the same effect is achievable.

In the embodiment of the present invention, the subject component may be any component besides the high contrast component as long as the subject component represents the component of a subject.

In the embodiments of the present invention, a case in which the present invention is applied to a radiographic image readout apparatus (CR: Computed Radiography) has been described. In the radiographic image readout apparatus, excitation light, such as a laser beam, is output to a storable phosphor sheet, and stimulated emission light is generated. Photoelectric conversion is performed on the stimulated emission light to obtain an image signal. The present invention is not limited to the aforementioned embodiments, and may be applied to any type of radiographic image readout apparatus using a grid. For example, the present invention may be applied to a radiographic image readout apparatus using a radiation solid-state detector (hereinafter referred to as a radiation solid-state detector of “light conversion type and indirect conversion type”), and in which plural photoelectric conversion elements, each corresponding to a pixel, are two-dimensionally formed on an insulation substrate. A phosphor layer (scintillator) that converts radiation carrying image information into visible light by irradiation with the radiation is deposited and constitutes the radiation solid-state detector formed on the radiation image readout apparatus. Further, the present invention may be applied to a radiography apparatus using a radiation solid-state detector (hereinafter referred to as a radiation solid-state detector of “direct conversion type”). Plural charge collecting electrodes, each corresponding to a pixel, are two-dimensionally formed on an insulation substrate in a radiographic image readout apparatus. A radiation conductor that generates charges carrying image information by irradiation with radiation carrying the image information is deposited, and constitutes the radiation solid-state detector formed on the two-dimensional image readout apparatus.

Further, the present invention may be applied to a radiographic image readout apparatus using various kinds of radiation solid-state detector. As a radiation solid-state detector of light conversion type, radiation solid-state detectors disclosed, for example, in Japanese Unexamined Patent Publication No. 59(1984)-211263, Japanese Unexamined Patent publication No. 2(1990)-164067, U.S. Pat. No. 5,187,369, L. E. Antonuk et al., “Signal, noise, and readout considerations in the development of amorphous silicon photodiode arrays for radiotherapy and diagnostic x-ray imaging”, Medical Imaging V: Image Physics, SPIE, Vol. 1443, pp. 108-119, 1991, and the like may be adopted.

Meanwhile, as a radiation solid-state detector of direct conversion type, radiation solid-state detectors disclosed for example in (i) a radiation solid-state detector, the thickness of which in the transmission direction of radiation is set about ten times as thick as an ordinary one (S. Quereshi et al., “MATERIAL PARAMETERS IN THICK HYDROGENATED AMORPHOUS SILICON RADIATION DETECTORS”, Journal of Non-Crystalline Solids, Vol. 114, Part 2, pp. 417-419, 1989), or (ii) a radiation solid-state detector, in which two or more layers are deposited in the transmission direction of radiation with a metal plate therebetween (Y. Naruse and T. Hatayama, “Metal/Amorphous Silicon Multilayer Radiation Detectors”, IEEE TRANSACTIONS ON NUCLEAR SCIENCE, Vol. 36, No. 2, pp. 1347-1352, 1989), or (iii) a radiation solid-state detector using CdTe or the like (Japanese Unexamined Patent Publication No. 1(1989)-216290) or the like may be adopted.

Each of the aforementioned embodiments is only an example, and all of the descriptions should not be used to interpret the technical scope of the present invention in a limited manner. Further, the system configuration, the hardware configuration, the process flow, the module configuration, the specific content of processing and the like may be modified in various manners without departing from the gist of the present invention. Such modifications remain in the technical scope of the present invention.

What is claimed is:

1. An image processing apparatus that suppresses a spatial frequency component corresponding to a periodic pattern included in an image, the apparatus comprising:
a first processed signal extraction unit that extracts a first processed signal by extracting an input spatial frequency component corresponding to the periodic pattern by performing filtering processing on an image signal representing the image;
a subject component extraction unit that extracts, from the extracted first processed signal, a subject component of the image, and the subject component being included in the first processed signal; and
a second processed signal extraction unit that extracts a second processed signal by subtracting the first processed signal from the image signal and also by adding the extracted subject component to the image signal.

2. The image processing apparatus, as defined in claim 1, wherein the subject component extraction unit extracts, from the first processed signal, a high contrast component exceeding a predetermined threshold, as the subject component.

3. The image processing apparatus, as defined in claim 2, wherein the threshold differs depending on an imaged region or an imaging condition of the image.

4. The image processing apparatus, as defined in claim 1, the apparatus further comprising:
a region extraction unit that extracts an imaged region of the image from the image.

5. The image processing apparatus, as defined in claim 1, the apparatus further comprising:
a periodic pattern detection unit that detects, in the image signal, the spatial frequency component corresponding to the periodic pattern, and that inputs the detected spatial frequency component into the first processed signal extraction unit.

6. The image processing apparatus, as defined in claim 1, wherein the second processed signal extraction unit extracts the second processed signal by subtracting the first processed signal from the image signal, and by adding the extracted subject component to the image signal after subtraction.

7. The image processing apparatus, as defined in claim 1, wherein the second processed signal extraction unit extracts the second processed signal by subtracting the extracted subject component from the first processed signal to obtain a signal, and by subtracting the obtained signal from the image signal.

8. An image processing method that suppresses a spatial frequency component corresponding to a periodic pattern included in an image, the method comprising the steps of:
extracting a first processed signal by extracting an input spatial frequency component corresponding to the periodic pattern by performing filtering processing on an image signal representing the image;
extracting, from the extracted first processed signal, a subject component of the image, and the subject component being included in the first processed signal; and
extracting a second processed signal by subtracting the first processed signal from the image signal and also by adding the extracted subject component to the image signal.

9. A non-transitory computer-readable recording medium storing therein an image processing program that suppresses a spatial frequency component corresponding to a periodic pattern included in an image, the program causing a computer to function as:
a first processed signal extraction unit that extracts a first processed signal by extracting an input spatial frequency component corresponding to the periodic pattern by performing filtering processing on the image signal;
a subject component extraction unit that extracts, from the extracted first processed signal, a subject component of the image, and the subject component being included in the first processed signal; and
a second processed signal extraction unit that extracts a second processed signal by subtracting the first processed signal from the image signal and also by adding the extracted subject component to the image signal.
